(19) United States
(12) Patent Application Publication
(10) Pub. No.: US 2010/0147119 A1
(43) Pub. Date: Jun. 17, 2010

(54) SIGNALING TORQUE DRIVER AND METHOD

(76) Inventor: BRIAN JAMES CUTLER, Rowland Heights, CA (US)

Correspondence Address: ITALIA IP, 3500 WEST OLIVE AVE., SUITE 300, BURBANK, CA, 91505, US

(21) Appl. No.: 12/713,471

(22) Filed: Feb. 26, 2010

Related U.S. Application Data
(63) Continuation-in-part of application No. 12/189,688, filed on Aug. 11, 2008.

(51) Int. Cl. B25B 23/144; B25B 23/16

(52) U.S. Cl. 81/479; 81/177.1

(57) ABSTRACT

A torque wrench assembly includes a casing assembly, a click arm, a signaling assembly and a torque-limiting assembly. The casing assembly includes an inward projection. The click arm is disposed within the casing assembly. The click arm has a first end adapted to engage a fastener, and a second end. The click arm is movable between first and second positions. The signaling assembly is coupled to the click arm and configured to engage the casing assembly inward projection when the click arm is moved to the click arm second position whereby the signaling system emits at least one of an audible, tactile, and visual notification. The torque-limiting assembly is disposed within the casing and operably coupled to the click arm second end and configured to permit the click arm to move from the first position to the second positing when a predetermined amount of torque has been reached.

### CROSS-REFERENCE TO RELATED APPLICATION

This application is a continuation-in-part of U.S. patent application Ser. No. 12/189,688 filed on Aug. 11, 2008.

### BACKGROUND

This application relates generally to driving tools such as screwdrivers, nut drivers, bolt drivers, wrenches and the like wherein the amount of torque that the tool can apply to a given fastener is limited to a settable value and the user is given a signal or indication that the desired torque level has been obtained. More specifically, this application relates to torque signaling mechanisms, such as visual, audible or tactile, usable in said tools that identifies when the desired torque is reached, thereby preventing the user from overtorquing a given fastening device.

This application relates to drivers that are able to give a user an improved signal that a desired torque level has been reached and is designed for uses where torque tolerances are critical. The need for a torque driver that can drive a given fastener at a desired torque value is useful in a variety of fields including sporting goods, electronics and computer assembly, and any other use where specific tolerances are required. However, it would be desirable if there were a tool that would allow a user an improved indication that the desired torque level has been obtained such that each time a fastener was torqued, the user was confident that the desired torque was properly obtained. It would also be desirable for such a tool to be low-cost and suitable for mass production without sacrificing precision.

### SUMMARY

This application discloses a signaling torque driver that is economical to produce, of simple construction and capable of mass production, but also capable of providing a clear indication to a user that the desired torque level has been obtained.

In one embodiment, a torque wrench assembly comprises a casing assembly having a inward projection; a click arm disposed within the casing assembly, the click arm having a first end adapted to engage a fastener and a second end, the click arm movable between a first position and a second position; a signaling assembly coupled to the click arm, the signaling assembly configured to engage the casing assembly inward projection when the click arm is moved to the click arm second position whereby the signaling system emits at least one of an audible notification, tactile notification and visual notification; and a torque-limiting assembly disposed within the casing and operably coupled to the click arm second end, the torque-limiting assembly configured to permit the click arm to move from the click arm first position to the click arm second positing when a predetermined amount of torque has been reached during rotation of a fastener engaged with the click arm first end.

In another embodiment, a casing for a torque wrench assembly, wherein the torque wrench assembly is configured to provide a predetermined amount of torque to a fastener in accordance with a predetermined torque setting, the casing comprises a first portion, the first portion including a recess configured to receive a label identifying the predetermined torque setting; a lens for covering the first portion recess, the lens configured to be releasably received by the first portion; a second portion configured to engage the first portion; and an interior cavity defined by the first portion and second portion and for retaining a substantial portion of the torque wrench assembly.

### BRIEF DESCRIPTION OF THE DRAWINGS

The drawings, when considered in connection with the following description, are presented for the purpose of facilitating an understanding of the subject matter sought to be protected.

FIG. 1 is a top plan view of a signaling torque driver;

FIG. 2 is a side e view of the driver FIG. 1;

FIG. 3 is a sectional view of the driver taken generally along the line 3-3 in FIG. 2;

FIG. 4 is a sectional view of the driver taken generally along the line 4-4 in FIG. 1;

FIG. 5 is a front view of the fastener-engaging portion of the driver in FIG. 1;

FIG. 6 is a cut-away perspective view of the driver in FIG. 1;

FIG. 7 is an exploded view of the driver in FIG. 1;

FIG. 8 is a perspective view of a second embodiment of a fastener-engaging portion;

FIG. 9 is an isolated sectional view similar to the view in FIG. 3 shown under a force to activate the signaling mechanism;

FIG. 10 is a cut-away perspective view of a second embodiment of the signaling torque driver; and,

FIG. 11 is an isolated sectional view of the driver in FIG. 10.

FIG. 12 is a plan view of an alternative driver;

FIG. 13 is an exploded isometric view of the driver of FIG. 12;

FIG. 14 is a isometric cross-sectional view of the driver of FIG. 12;

FIG. 15A is a side view of the driver of FIG. 12; and

FIG. 15B is a cross-sectional view taken along line B-B is FIG. 15A.

### DETAILED DESCRIPTION

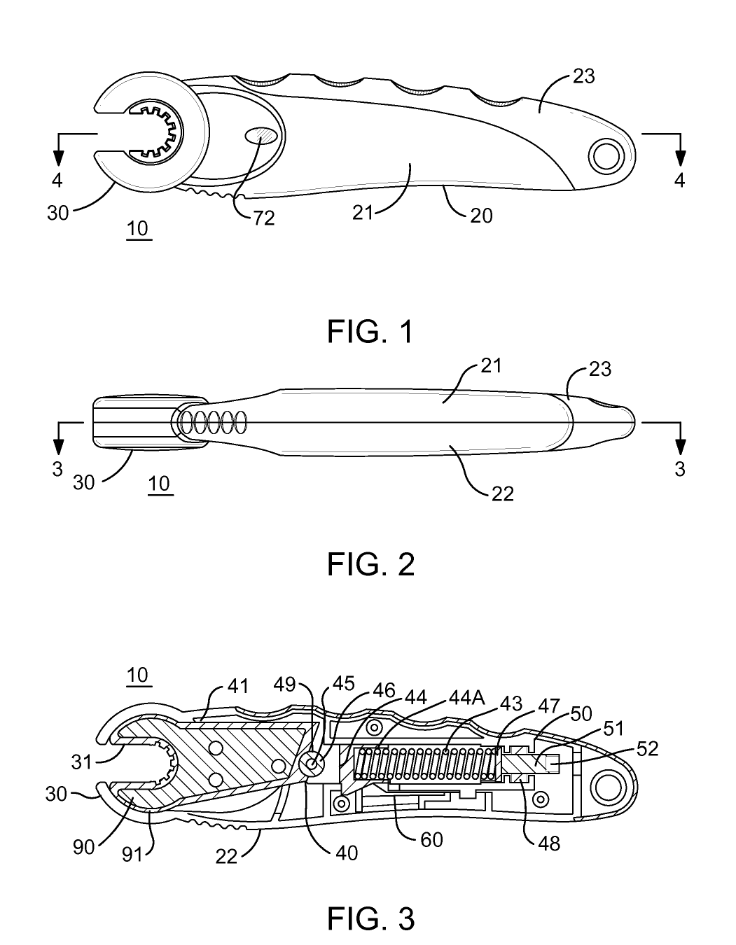

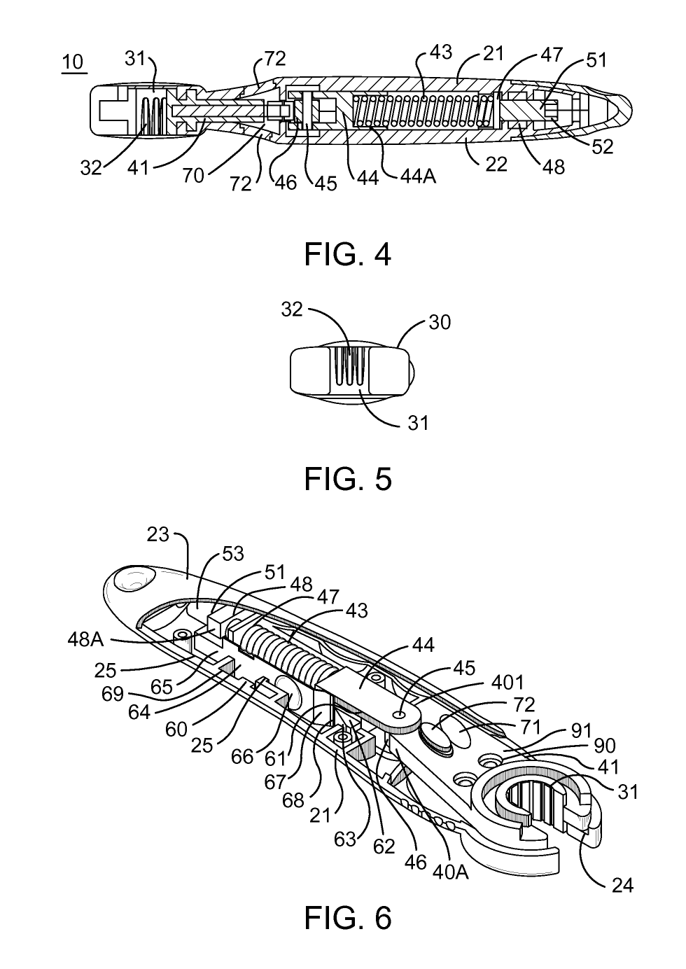

Referring to FIGS. 1-5, shown therein and generally designated by the reference character 10 is the preferred embodiment of the signaling torque driver 10 constructed in accordance with the following description. The driver 10 includes a casing assembly 20, a fastener-engaging portion 30, a torque-limiting mechanism 40, an adjusting mechanism 50, an audible signaling mechanism 60, and/or a visual signaling mechanism 70.

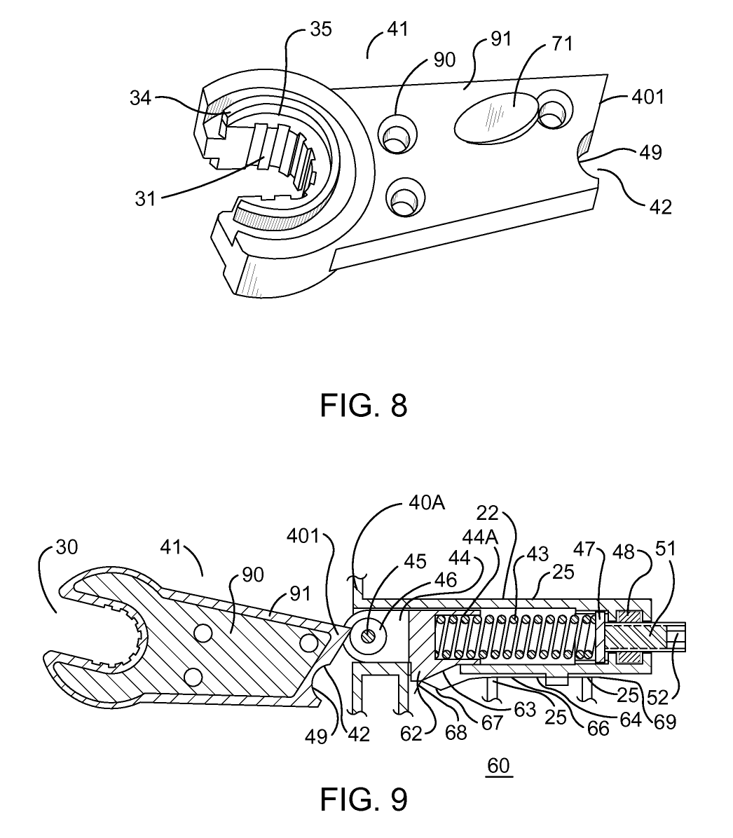

As may be seen more clearly in FIGS. 5 and 8, the fastener-engaging portion 30 is adapted to engage a fastener (not shown), and includes a shaped inner surface 31 adapted to mateably receive a fastener. The inner surface 31 may include driver orientation means such as channels 32 that in one embodiment only span a portion of the inner surface 31 such that the driver can only engage a fastener in one direction and ensures that driver is in the correct orientation when the operator attaches it to a given fastener. See FIG. 5. In a second embodiment 33, the upper surface 34 of the fastener-engaging portion 30 may include driver orientation means such as an orientation limiting rim 35 that ensures that driver is in the correct orientation when the operator attaches it to a given fastener. The correct driver orientation allows the user to tighten the fastener while taking advantage of the desired torque-limiting and signaling means. The fastener-engaging portion 30 is integral with a click arm 41 that and extends into and sits within the casing assembly 20. The casing assembly 20, which includes top and lower portions 21 and 22 and a grip portion 23 and forms the handle portion of the driver, remains stationary as the fastener-engaging portion 30 is maintained between and is able to pivot within the channels 24 of the top and lower portions 21 and 22. The distal end of the click arm 41 is operably associated with the torque-limiting mechanism 40 as discussed in more detail below.

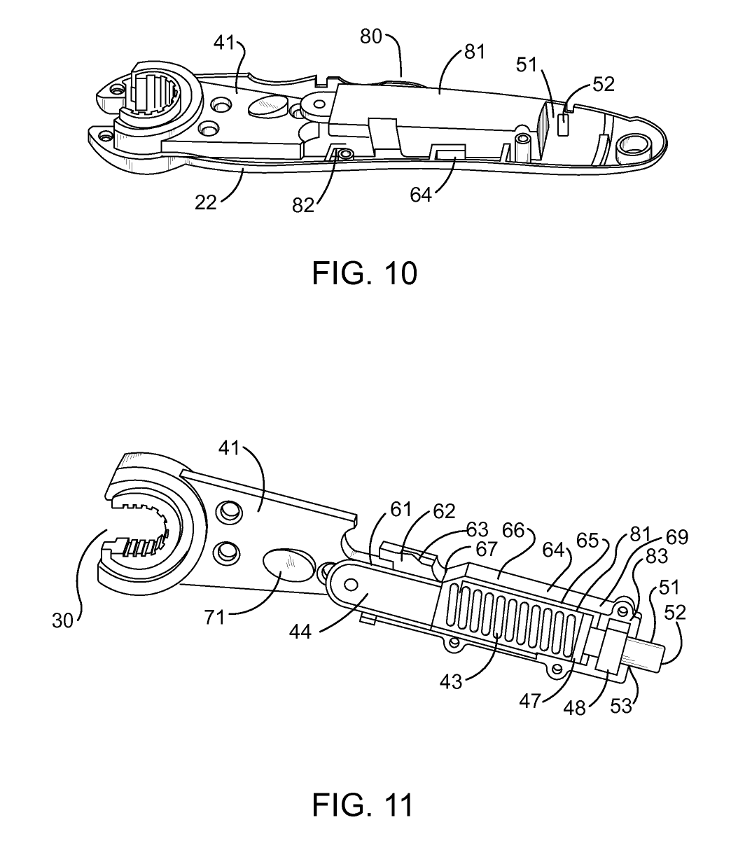

As may be seen more clearly in FIGS. 3, 4 and 6, the torque-limiting mechanism 40 disposed within the casing assembly 20 includes a click arm 41 with its cam surface 42, a spring 43, a cam follower 44 with its pin 45 and roller 46, a shim 47, a locking nut 48, and an adjustment plug 51. The spring 43 is disposed between a recessed portion 44A of the cam follower 44 and the shim 47. The cam follower 44 includes a roller 46 mounted rotateably to said follower 44 body by means of a rotateable pin 45, and together with the spring 43, shim 47, locking nut 48, and adjustment plug 51 serves to create a force when the spring 43 is compressed on the cam follower 44 which engages the roller 47 into the distal end of the click arm 41, more specifically, the detent radius 49 of the click arm 41. The distal end of the click arm 41 also includes an angled edge 401 that receives the roller 46 when the force applied to the driver overcomes the force of the spring 43 upon the cam follower 44. Preferably, the click arm 41 includes a metal core 90 for strength and integrity and a moldable plastic like covering 91 about its surface and within the fastener-engaging portion 30 to help prevent damage to the fastener the driver 10 is engaged upon. The force is applied to the spring 43 by the adjustment plug 51 given it is threaded surface 53 and is received through a threaded bore 48A in the locking nut 48. As the plug 51 is rotated in a given direction, a force is applied to the shim 47 and the adjacent spring 43 is compressed (discussed more fully below). The locking nut 48 is held in position by utilizing inner surfaces 25 of the top and lower portions 21 and 22 of the casing assembly 20, such that the locking nut is mateably received and unable to rotate given the abutment to the inner surfaces 25. Alternatively, as shown in FIGS. 10 and 11, an inner casing assembly 80 may be utilized to house and maintain the integrity of the torque-limiting mechanism 40. As shown, the inner casing assembly 80 is substantially rectangular shaped and includes upper and lower portions 81 and 82 and is used to house a portion of the cam follower 44, the spring 43, the shim 47, the locking nut 48, and portion of the adjustment plug 51. The inner casing assembly 80 includes inner surfaces 83 that abut the surface of the locking nut 48 and hold it in place so that the desired torque can be set and maintained.

The audible signaling mechanism 60 for signaling that the desired torque has been achieved on a given fastener is shown in FIGS. 6 and 9. The audible signaling mechanism 60 includes the cam follower 44 with a lateral surface 61 and a clicker cam 62 with an angled edge 63 integrated upon said surface 61, and a clicker 64. The clicker 64 includes a planer surface 65 and integrated therein a substantially circular convex surface 66 and a flanged portion 67 located at a first end 68. The convex surface 66 extends in an outward lateral direction relative to the spring 43. The second end 69 of the clicker 64 is held in position by utilizing the inner surfaces 25 of the top and lower portions 21 and 22 of the casing assembly 20, however, the first end 68 is left relatively unobstructed so that the first end 68 can be deflected a given distance. The audible signaling mechanism 60 then proceeds, briefly, as follows: As the click arm 41 is displaced due to a radial force on the grip portion 23 that exceeds the spring force on the cam assembly 40A (click arm 41 and cam follower 44), the first end 68 of the clicker 64 is deflected causing the convex surface 66 to depress and emanate a “click” sound. The clicker 64 is preferably made of thin metal materials so to provide enough flexibility for deflection and the “click” sound. When the force applied by the operator is lessened to a level below the spring force on the cam assembly 40A the clicker 64 returns back to its initial position. The audible signaling mechanism 60 is discussed more fully below.

In use, the adjustment of the driver 10 is accomplished by utilizing the adjusting mechanism 50, which includes the adjustment plug 51, which is characterized by having a socket 52 at its distal end that is mateably shaped to receive an adjustment tool (not shown) and further characterized by an annular externally threaded surface 53 that is mateably received by the internally threaded bore 48A of the locking nut 48. As the adjustment plug 51 is rotated to cause axial movement, this in turn creates an axial force on the torque-limiting mechanism; namely, the shims 47, and compression of the spring 43 against the cam assembly 40A. The spring 43 can be compressed to correspond to a desired torque limit. The torque limit of the driver 10 can be adjustable by a user or fixed at a specific setting once assembled. When a radial load is applied to the grip portion 23 in a direction perpendicular to the axis of the driver 10 and on a parallel plane consistent with the click arm 41 the torque moment force rises on the fastener engaged by the fastener-engaging portion 30 to the desired torque setting which causes the roller 46 to lift from the detent radius 49 and as more force is applied by the operator, onto the angled edge 401 (FIG. 9). As the torque applied by the user exceeds the force of the spring 43, and the roller 46 is lifted from the detent radius 49, the roller 46 begins to ride upon the angled edge 401 of the cam surface 42, which in turn causes cam follower 44 to be forced toward the distal end of the driver 10 as the spring 43 is compressed. As the cam follower 44 is forced to the distal end of the driver 10, the flanged portion 67 of the clicker 64 is forced upon the angled edge 63 of the clicker cam 62. This in turn causes the clicker 64 to deflect and the convex surface 66 to depress and emanate a “click” sound; thereby providing an audible indication that the applied load on the grip portion 23 has reached the desired torque setting of the driver 10. The angled edge 401 allows the click arm 41 to be forced by the roller 46 back to the start location in the detent radius 49 by the force of the spring 42 as the force against the grip portion 23 is reduced, thereby causing the cam follower 44 to return to its start location and the clicker 64 to return to its non-deflected state.

The visual signaling mechanism 70 for signaling that the desired torque has been achieved on a given fastener is shown in FIGS. 1 and 6. The visual signaling mechanism 70 utilizes a pair of indicators 71 located on opposite sides of the click arm 41. The indicators 71 may be colored so that they contrast with the color of click arm 41. The visual signaling mechanism 70 also includes a pair of windows 72 fixably attached within bores 24 on the upper and lower portions 21 and 22 of the casing assembly 20. In the resting state, the indicators 71 are hidden from view under the upper and lower portions 21 and 22 of the casing assembly 20. In operation (as described more fully above), when a radial load is applied to the grip portion 23 in a direction perpendicular to the axis of the driver 10 and on a parallel plane consistent with the click arm 41 the torque moment force rises on the fastener engaged by the fastener-engaging portion 30 to the desired torque setting which causes the roller 46 to lift from the detent radius 49 and as more force is applied by the operator, onto the angled edge 401 (FIG. 9). This causes the click arm 41 to deflect a given distance and the indicators 71 to now come in position under the windows 72 and thereby viewable to the operator; thereby indicating that the desired torque setting has been obtained.

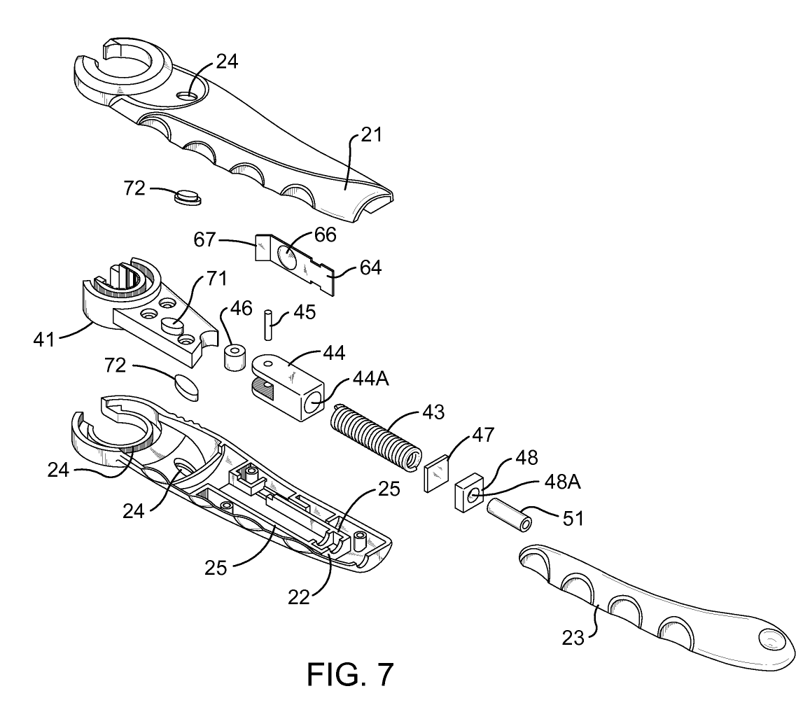

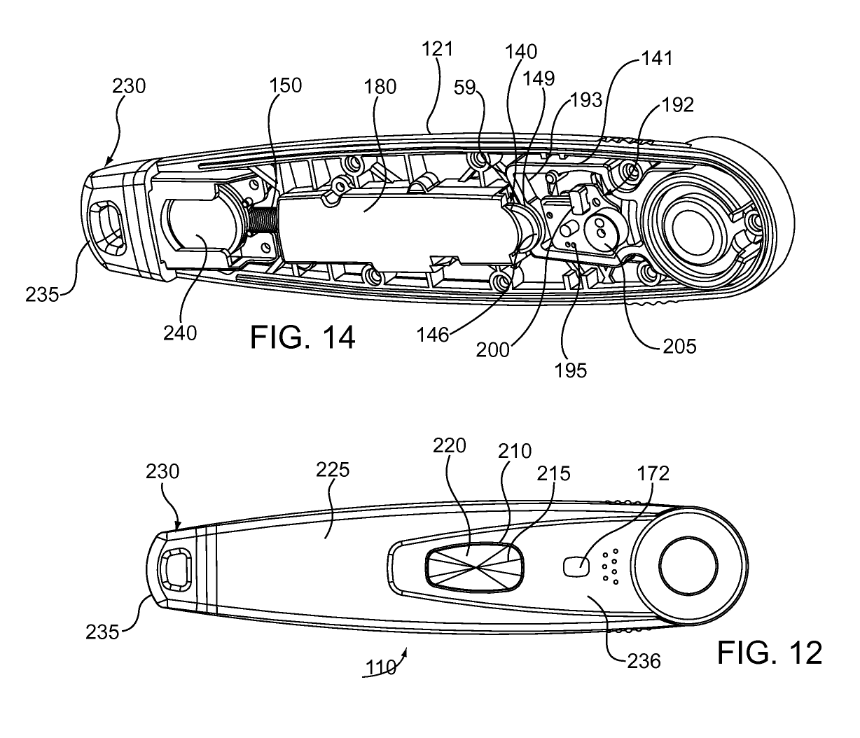

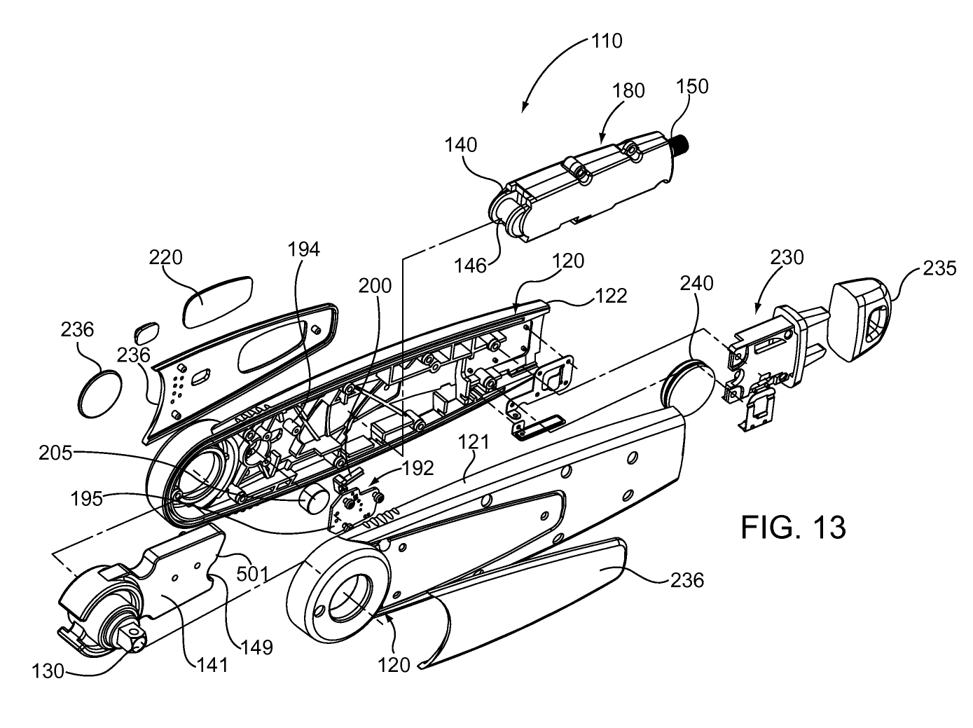

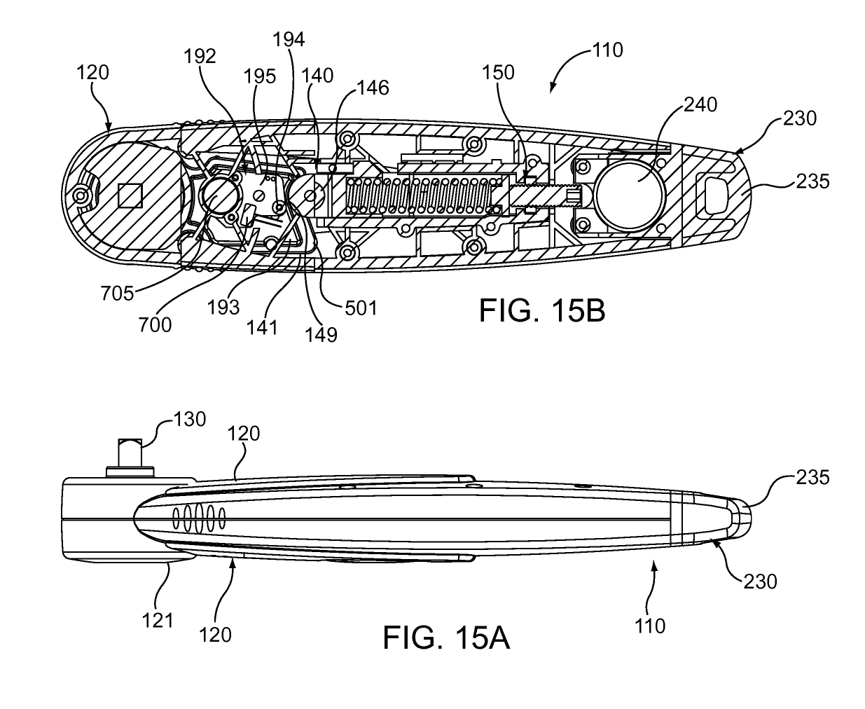

Referring now to FIGS. 11-15B, an alternative embodiment of a torque driver 110 is shown. The driver 110 is analogous in most respects to the driver 10 of FIGS. 1-10 and a correlation of parts is generally indicated in this embodiment by indexing the numerals in FIGS. 1-10 by 100. Generally, the driver 110 includes a casing assembly 120, a fastener engaging portion 130, a torque-limiting mechanism 140, and an adjusting mechanism 150. While the fastener engaging portion 130 is shown as a socket-engaging head, it will be appreciated that the fastener engaging portion may be a wrench head, such as an open-end wrench head, and remain within the scope of the present disclosure. Also, unlike the casing assembly 20 of prior embodiments, and as will be discussed further below, the top portion 121 of the casing assembly 120 includes an inward projection 194 for engaging the signaling assembly 192 when the predetermined amount of torque has been reached.

The driver 110 includes a signaling assembly 192. The click arm 141 includes a recess 193 for receiving the signaling assembly 192 and the signaling assembly 192 is rigidly coupled to the click arm 141. The signaling assembly 192 includes a PCB board 195, a switch 200 in communication with the PCB board 195 and an electronic buzzer 205 in communication with the PCB board 195. As described above, when the predetermined amount of torque has been reached, the click arm 141 begins to rotate and the roller 146 of the torque limiting mechanism 140 lifts from the detent radius 149 of the click arm 141 and advances up the angled surface 501 of the click arm 141. In the present embodiment, once the click arm 141 has rotated from a first position, the position of the click arm 141 prior to the predetermined amount of toque being reached where a fastener engaged therewith may be rotated, to a second position, at the end of the rotation of the click arm 141 after the predetermined amount of torque has been reached, the switch 200 comes in contact with the inward projection 194 of the casing assembly 120 whereby the buzzer 205 is activated such that at least one of an audible notification and tactile notification is emitted to alert a user that the predetermined amount of torque on the fastener has been achieved. While the present embodiment employs a buzzer 205, it will be appreciated that the signaling assembly 192 may employ any suitable means or device to emit at least one of an audible notification, visual notification, and tactile notification to alert a user that the predetermined amount of torque on the fastener has been achieved. For example, and without limitation, the signaling assembly 192 may include at least one of a loudspeaker, an unbalanced electronic vibration motor, a buzzer, a light (such as an LED), clicker or any other suitable device or means. In one embodiment, the signaling assembly 192 includes a light for notifying the user that a predetermined amount of torque has been achieved. The light may emit through a window 172 in the casing assembly 120.

The casing assembly 120 of the present embodiment may also be configured to identify for the user the torque setting for the driver 110. In the illustrative embodiment, the casing assembly 120 includes a top portion 121 and a lower portion 122. The top portion 121 includes a recess 210 adapted to receive a label 215. In one embodiment, the label 215 includes information related to the torque setting of the driver 110; however, it will be appreciated that the label may include any suitable information and remain within the scope of the present disclosure—for example, and without limitation, the label may include a person's name, a company name, or any other suitable information. The casing 120 may include a lens 220 for retaining the label 215 within the recess 210. The lens 220 may be configured to be releasably received by the top portion 121 of the casing 120 such that the label 215 may be selectively changed by a user.

Further, in one embodiment, the casing assembly 120 includes an elastomeric covering 225. In one embodiment, the covering 225 is configured to releasably engage the lens 220 such that the lens 220 remains atop the recess 210 of the top portion 121. The elastomeric covering 225 may be configured to cover one or both of the casing portions 121, 122 and provide enhanced grip of the driver 110 as well as absorb shock should the driver 110 be dropped. The casing assembly 120 may also include decorative elements 236 to enhance the look of the driver 110.

The casing assembly 120 may further include an end portion 230. In one embodiment, the end portion 230 retains the one or more batteries 240 for powering the signaling assembly 192 within the interior cavity of the casing assembly 120. The end portion may also include a loop 235 configured to absorb shock if the driver 110 is dropped on its end. In one embodiment, the loop 235 includes a plastic core and an elastomeric exterior. However, it will be appreciated that the end portion 230 may have any suitable configuration and remain within the scope of the present disclosure.

While the present disclosure has been described in connection with what is considered the most practical and preferred embodiment, it is understood that that this disclosure is not limited to the disclosed embodiments, but is intended to cover various arrangements included within the spirit and scope of the broadest interpretation so as to encompass all such modifications and equivalent arrangements. To that end, various torque-limiting mechanisms are known in the prior art that are adaptable to the disclosed signaling means.

What is claimed is:

1. A torque wrench assembly comprising:
a casing assembly having a inward projection;
a click arm disposed within the casing assembly, the click arm having a first end adapted to engage a fastener and a second end, the click arm movable between a first position and a second position;
a signaling assembly coupled to the click arm, the signaling assembly configured to engage the casing assembly inward projection when the click arm is moved to the click arm second position whereby the signaling system emits at least one of an audible notification, tactile notification and visual notification; and
a torque-limiting assembly disposed within the casing and operably coupled to the click arm second end, the torque-limiting assembly configured to permit the click arm to move from the click arm first position to the click arm second positing when a predetermined amount of torque has been reached during rotation of a fastener engaged with the click arm first end.

2. The torque wrench assembly of claim 1 wherein the signaling assembly includes a loudspeaker to emit an audible notification when the signaling assembly engages the casing assembly inward projection.

3. The torque wrench assembly of claim 1 wherein the signaling assembly includes an unbalanced electronic vibration motor configured to emit a tactile notification when the signaling assembly engages the casing assembly inward projection.

4. The torque wrench assembly of claim 1 wherein the signaling assembly includes a buzzer configured to emit at least one of a audible notification and tactile notification when the signaling assembly engages the casing assembly inward projection.

5. The torque wrench assembly of claim 1 wherein the signaling assembly includes a light-emitting device configured to emit a visual notification when the signaling assembly engages the casing assembly inward projection.

6. The torque wrench assembly of claim 1 wherein the signaling assembly includes a clicker configured to emit at least one of a audible and tactile notification when the signaling assembly engages the casing assembly inward projection.

7. The torque wrench assembly of claim 1 further comprising a torque-adjusting assembly disposed within the casing and coupled to the torque limiting assembly and configured to adjust the torque limiting assembly to a desired torque value.

8. The torque wrench assembly of claim 1 wherein the signaling assembly includes a switch for engaging the casing assembly inward projection when the click arm is moved to the click arm second position.

9. The torque wrench assembly of claim 1 wherein the click arm first end includes a wrench head.

10. The torque wrench assembly of claim 10 wherein the wrench head is an open-end wrench head.

11. The torque wrench assembly of claim 1 wherein the click arm first end includes a socket.

12. The torque wrench assembly of claim 1 wherein the torque-limiting assembly includes a cam follower, wherein the cam follower is in communication with the click arm.

13. A casing for a torque wrench assembly, wherein the torque wrench assembly is configured to provide a predetermined amount of torque to a fastener in accordance with a predetermined torque setting, the casing comprising:
a first portion, the first portion including a recess configured to receive a label identifying the predetermined torque setting;
a lens for covering the first portion recess, the lens configured to be releasably received by the first portion;
a second portion configured to engage the first portion; and
an interior cavity defined by the first portion and second portion and for retaining a substantial portion of the torque wrench assembly.

14. The casing of claim 13 further comprising an elastomeric covering adapted to receive at least a portion of each of the first portion and second portion.

15. The casing of claim 13 further comprising an end, the end configured to provide shock absorption when the casing is dropped.

16. The casing of claim 15 wherein the end is configured as a loop.

17. The casing of claim 15 wherein the end includes an elastomeric portion.
